(19) United States
(12) Patent Application Publication
(10) Pub. No.: US 2010/0078923 A1
(43) Pub. Date: Apr. 1, 2010

(54) Moving body receiving system

(75) Inventors: Shigeyuki Suzuki, Aichi-ken (JP); Michio Inoue, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/585,169

(22) Filed: Sep. 8, 2009

(30) Foreign Application Priority Data
Sep. 29, 2008 (JP) 2008-251145

(51) Int. Cl. B60R 21/16

(52) U.S. Cl. 280/743.1

(57) ABSTRACT

A receiving system is installed on a vehicle and feeds out, when actuated, a receiving holder portion from a waiting position to a receiving position where the receiving holder portion can receive a moving body. The receiving system includes a holder base which is fixed to a waiting position side of the receiving holder portion, a drive mechanism and a plastically deformable member. The drive mechanism is connected to the holder base and the receiving holder portion and receives, when actuated, a drive force transmitted from a drive source, so as to feed out the receiving holder portion from the waiting position to the receiving position. The plastically deformable member is formed as a separate element from the receiving holder portion and is arranged so as to be supported on the holder base and the receiving holder portion, whereby when the receiving holder portion which has been disposed in the receiving position moves towards the waiting position side, the plastically deformable member is plastically deformed so as to absorb the kinetic energy of the moving body.

### BACKGROUND OF THE INVENTION

1. Field of the Invention

The present invention relates to a moving body receiving system which is installed on a vehicle and is adapted, when actuated, to feed out a receiving holder portion from a waiting position to a receiving position where the receiving holder portion can receive a moving body and absorb kinetic energy of the moving body when the receiving holder portion which has received the moving body moves towards the waiting position and more specifically to a moving body receiving system for receiving a moving body such as knees or an upper-half body of an occupant of the vehicle such as the driver or a front seat passenger when the vehicle is involved in a collision, a pedestrian himself or herself who is hit by the vehicle or a hood panel on an upper surface of which the pedestrian hit by the vehicle is resting so as to stop the moving body with safe by reducing the kinetic energy thereof.

2. Related Art

Conventionally, as a receiving system of this type, there have been knee protection systems for receiving the knees of an occupant as a moving body to be received in which a receiving holder portion for protecting the knees of the occupant is fed out from a waiting position to a receiving position where the receiving holder portion can receive the knees of the occupant, when the vehicle is involved in a collision (for example, refer to JP-A-2005-280463). In the knee protection system as the receiving system, the receiving holder portion (the knee protection panel) is disposed in advance in the waiting position lying in front of the knees, and a drive mechanism which holds the receiving holder portion movably is connected to the receiving holder portion. This drive mechanism is made to include a support panel having a sufficient rigidity to support the receiving holder portion and an actuator which has a drive rod which supports the support panel. The actuator is made up of a hydraulic cylinder or the like for feeding out the drive rod. In addition, the receiving holder portion is made to include a panel main body adapted to be brought into abutment with the knees of the occupant which move forwards and an impact absorbing material. The impact absorbing material is disposed between the panel main body and the support panel and is designed to be deformed when compressed so as to narrow a distance between the panel main body and the support panel as a result of the panel main body being brought into abutment with the knees to thereby be moved forwards so as to absorb the kinetic energy of the knees, so that the knees are received with safety to be stopped.

In addition, in the knee protection systems as the receiving system, there have been those in which a piston cylinder type actuator is used which incorporates therein a gas generator (for example, refer to JP-A-2005-280465). In this knee protection system, a receiving holder portion (a knee restraint) is arranged so as to be connected to a working rod of an actuator, and when the actuator is actuated, the knee restraint is fed out together with the working rod to a knee receiving position. Then, when receiving the knees, the working rod and the knee restraint are caused to move backwards while a gas is being controlled to be discharged from vent holes having a small opening diameter which are provided in the cylinder of the actuator, so that the kinetic energy of the knees is made to be absorbed by the controlled discharge of the gas from the vent holes.

In the former conventional receiving system, however, in the receiving holder portion, the impact absorbing material which deforms plastically is provided between the support panel of the drive mechanism and the main body panel main body, and in the event that the impact absorbing material plastically deforms by an amount corresponding to its thickness in a front-rear direction, the panel main body cannot move, and because of this, there has been room for improvement in increase of the absorbing amount of kinetic energy while enabling a further movement of the receiving holder portion towards the waiting position side.

In addition, in the later receiving system, the knees can be received while absorbing the kinetic energy of the knees over a range of a long stroke along which the receiving holder portion moves until the vent holes are closed. In this receiving system, however, the kinetic energy of the knees is designed to be absorbed by virtue of resistance produced when the gas for actuating the actuator is discharged, and compared with the case where the kinetic energy is absorbed by the plastic deformation of the impact absorbing material, it is inevitable that the reaction force exerted on the knees by the knee restraint becomes high due to the amount of the gas discharged through the vent holes becoming insufficient when the knees having the high kinetic energy strike the knee restraint, and there has been room for improvement in this respect.

### SUMMARY OF THE INVENTION

The invention was made with a view to solving the problems described above, and an object thereof is to provide a moving body receiving system which can absorb kinetic energy of a moving body by virtue of elastic deformation of a plastically deformable member and can easily ensure a long moving stroke when absorbing the kinetic energy.

According to an aspect of the invention, there is provided a moving body receiving system which is installed on a vehicle and is adapted, when actuated, to feed out a receiving holder portion from a waiting position to a receiving position where the receiving holder portion can receive a moving body and absorb kinetic energy of the moving body when the receiving holder portion which has received the moving body moves towards the waiting position, including:

a holder base which is fixed to a waiting position side of the receiving holder portion;

a drive mechanism connected to the holder base and the receiving holder portion to receive a drive force transmitted from a drive source so as to feed out the receiving holder portion from the waiting position to the receiving position; and

a plastically deformable member separately formed from the receiving holder portion, is supported on the holder base and either the receiving holder portion or the drive mechanism and is made to be plastically deformed when the receiving holder portion which is placed in the receiving position moves back towards the waiting position so as to absorb the kinetic energy of the moving body.

In the moving body receiving system according to the invention, when actuated, the drive mechanism connected to the holder base and the receiving holder portion is actuated by the drive force from the drive source to feed out the receiving holder portion from the waiting position which is situated on the holder base side to the receiving position. Then, the moving body is received by the receiving holder portion which is disposed in the receiving position, and further, when the receiving holder portion moves to the waiting position side together with the moving body, the plastically deformable member is plastically deformed to thereby absorb the kinetic energy of the moving body.

As this occurs, the plastically deformable member is configured as the separate element from the receiving holder portion and is arranged so as to be supported on the holder base and either the receiving holder portion or the drive mechanism. In this configuration, when the receiving holder portion moves towards the holder base side, the supported portion of the plastically deformable member which is supported on the receiving holder portion or the drive mechanism moves relative to the support portion thereof which is supported on the holder base in accordance with an amount in which the receiving holder portion has moved, as a result of which the plastically deformable member is deformed plastically so as to be bent, compressed or buckled so as to absorb the kinetic energy of the moving body. In other words, the plastically deformable member is not interposed between the receiving holder portion and the drive mechanism and is supported on the holder base side at the one end portion, while it is supported on either the receiving holder portion or the drive mechanism at the other end thereof. In this configuration, even though the receiving holder portion is caused to move from the receiving position to a position lying in the vicinity of the waiting position, the plastically deformable member is allowed to be plastically deformed along the full length of the long moving stroke thereof.

In addition, the absorption of kinetic energy of the moving body is implemented not through the damper mechanism which employs the controlled discharge of gas from the vent holes but through the plastic deformation of the plastically deformable member, and consequently, the plastically deformable member is plastically deformed in a smooth fashion without imparting in any case a high reaction force to the moving body when the receiving holder portion receives the moving body having the high kinetic energy, thereby making it possible to absorb a predetermined amount of kinetic energy.

Consequently, in the moving body receiving system according to the invention, the kinetic energy of the moving body can be absorbed by virtue of the plastic deformation of the plastically deformable member, and the long moving stroke can easily be ensured when absorbing the kinetic energy.

In addition, in the moving body receiving system according to the invention, it is desirable that the plastically deformable member is interposed between the receiving holder portion which is being placed to the receiving position and the holder base and is arranged such that one of both ends thereof is made to be supported on the receiving holder portion side and the other is made to be supported on the holder base side.

In the configuration described above, the plastically deformable member is not connected to the drive mechanism but is made to be supported directly on the receiving holder portion which moves towards the waiting position side at the other end portion in such a state that the plastically deformable member is made to be supported on the holder base side at the one end portion thereof. Because of this, since the plastically deformable member can directly be pressed against by the receiving holder portion itself to thereby be plastically deformed when the receiving holder portion moves towards the waiting position side, the absorbing amount of kinetic energy is made to correspond accurately and easily to the moving stroke of the receiving holder portion towards the waiting position side, thereby making it possible to absorb the kinetic energy of the moving body in a smooth fashion.

In addition, it is desirable that the drive mechanism is made up of parallel link mechanisms in each of which two equally long links are disposed to intersect each other on either of corresponding edge sides of the holder base and the receiving holder portion with both end portions of each link connected, respectively, to the holder base and the receiving holder portion which are made to function as link pieces which are parallel to each other.

With the parallel link mechanisms which are configured as described above, the drive mechanism can be stored within a volume which corresponds to a thickness defined between the receiving holder portion and the holder base when the receiving holder portion is disposed in the waiting position, whereby the moving body receiving system can be made compact.

In this case, it is desirable that the drive source is made up of a cylinder-type actuator in which a working rod is made to project from a cylinder when actuated and that the actuator is arranged such that an axial direction of the cylinder is made to follow a moving direction of the end portion of one of the two links which are disposed on one of the edge sides on the holder base side and a distal end of the working rod is connected to the end portion of the one of the two links so that when actuated, the end portion of the one of the two links moves in a direction in which it approaches the corresponding end portion of the other of the two links.

In the configuration described above, also in the actuator which functions as the drive source, since the projecting direction of the working rod which is fed out when the actuator is actuated is referred to as a direction which is at right angles to the feeding direction of the receiving holder portion towards the receiving position and as the direction which follows the moving direction of the end portion of the link, the axial direction of the cylinder does not have to be oriented so as to become bulky in the feeding out direction of the receiving holder portion. Because of this, in the configuration like this, the whole moving body receiving system can be formed compact and thin as a result of the thickness dimension of the same system being reduced which follows along the feeding out direction of the receiving holder portion.

### BRIEF DESCRIPTION OF THE DRAWINGS

FIG. 1 is a schematic vertical sectional view of a receiving system of a first embodiment according to the invention.

FIG. 2 is a front view of the receiving system of the first embodiment as viewed from the rear of a vehicle.

FIGS. 3A and 3B are schematic horizontal sectional views of the receiving system of the first embodiment when it is actuated, which corresponds to a portion taken along the line III-III in FIG. 2.

FIG. 4 is a schematic perspective view of the receiving system of the first embodiment, which shows a state in which a receiving holder portion is disposed in a receiving position.

FIG. 5 is a schematic perspective view of the receiving system of the first embodiment, which shows a state in which the receiving holder portion is disposed in a waiting position.

FIGS. 6A and 6B are schematic horizontal sectional views showing the state in which the receiving system of the first embodiment is actuated.

FIGS. 7A and 7B are schematic horizontal sectional views showing a state in which the receiving system of the first embodiment which has been actuated is receiving knees to absorb the kinetic energy of the knees.

FIG. 8 is a schematic perspective view of a receiving system of a second embodiment, which shows a state a state in which a receiving holder portion is disposed in a receiving position.

FIGS. 9A and 9B are schematic horizontal sectional views showing the receiving system of the second embodiment when it is actuated.

FIGS. 10A and 10B are schematic horizontal sectional views showing a state in which the receiving system of the second embodiment which has been actuated is receiving knees to absorb the kinetic energy of the knees.

FIG. 11 is a schematic perspective view of a receiving system of a third embodiment when it is actuated, which shows a state in which a receiving holder portion is disposed in a receiving position.

FIGS. 12A and 12B are schematic horizontal sectional views of the receiving system of the third embodiment when it is actuated.

FIGS. 13A and 13B are schematic horizontal sectional views showing a state in which the receiving system of the third embodiment which has been actuated is receiving knees to absorb the kinetic energy of the knees.

### DETAILED DESCRIPTION OF THE PREFERRED EMBODIMENTS

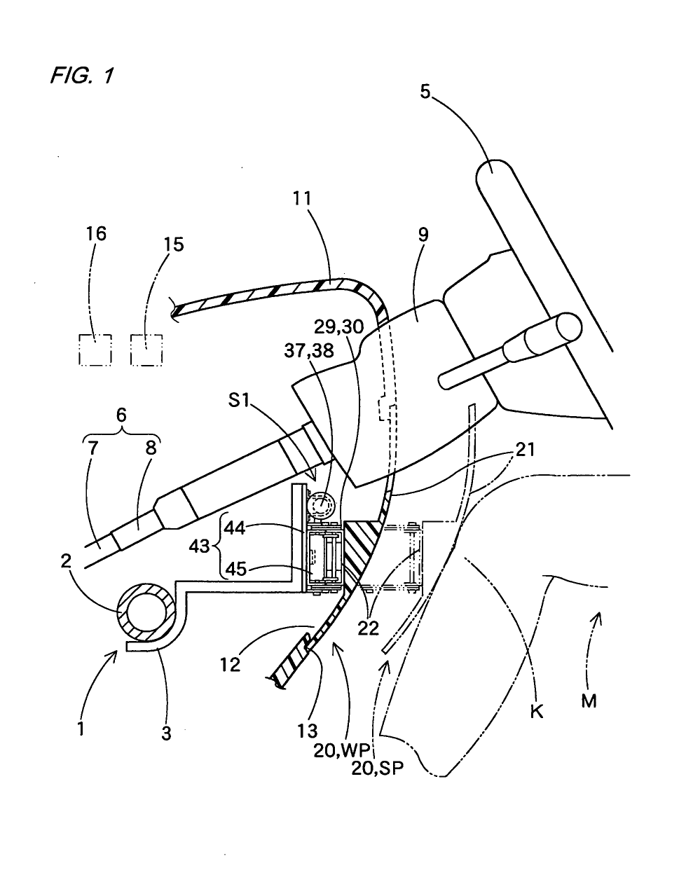

Hereinafter, a receiving system S1 of a first embodiment of the invention will be described based on the drawings. As is shown in FIGS. 1 to 3B, the receiving system S1 of the first embodiment is designed to receive knees K of a driver M who is an occupant of a vehicle as a moving body to be received and is provided below a steering column 6 which lies in front of the driver M as viewed in a front-rear direction of the vehicle.

Note that when used in this specification, directions such as top-bottom, front-rear and left-right directions are understood to be based on a state in which the receiving system S1 is installed on the vehicle and correspond to top-bottom, front-rear and left-right directions of the vehicle when the receiving system is installed on the vehicle.

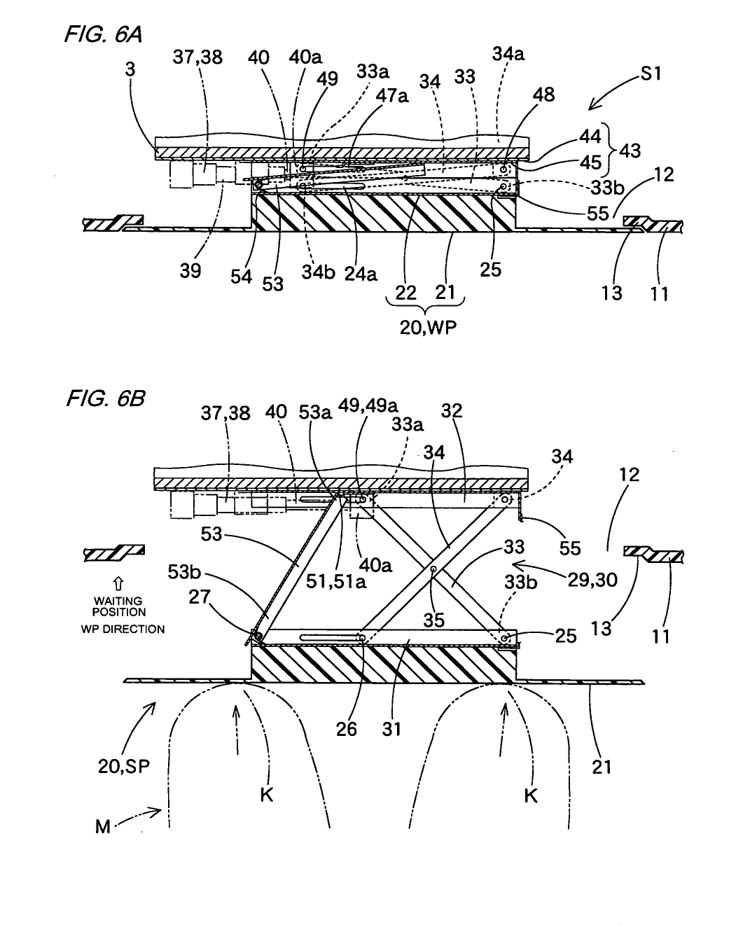

As is shown in FIGS. 6A and 6B, the steering column 6 is made to include a main shaft 7 which is connected to a steering wheel 5, a column tube 8 which covers a circumference of the main shaft 7 and a column cover 9 which covers a circumference of the column tube 8. The column cover 9 is provided so as to project obliquely upwards and rearwards from an instrument panel 11 which functions as an interior material.

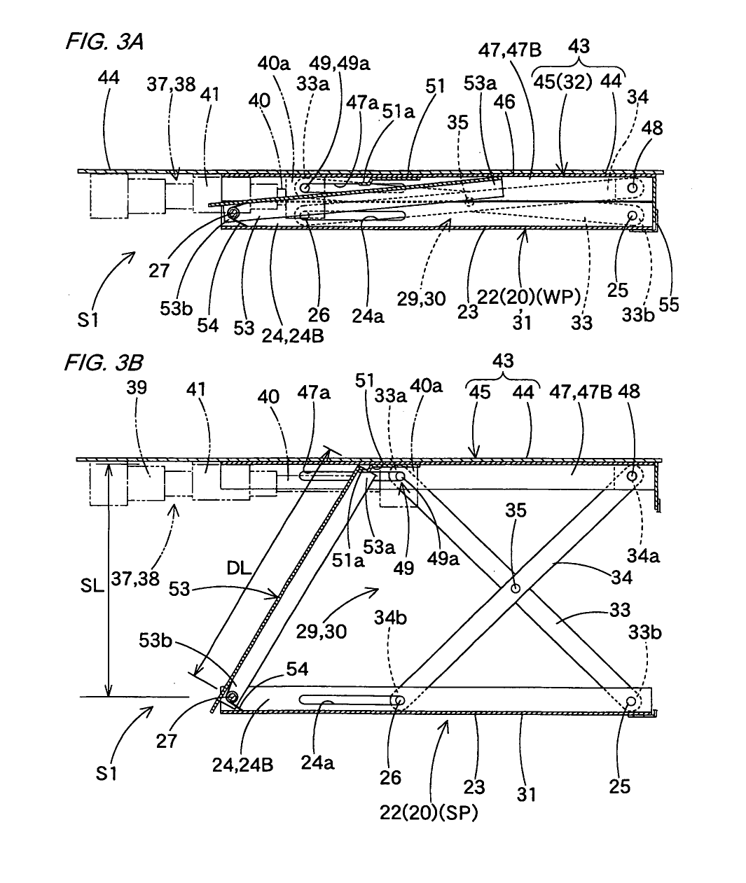

The receiving system S1 is configured, as is shown in FIGS. 3A, 3B, 6A and 6B, so as to feed out a receiving holder portion 20 for receiving the knees K as a moving body from a waiting position WP to a sizing position SP where the receiving holder portion can receive the knees K when the vehicle is involved in a frontal collision and is made to include the receiving holder portion 20, a drive mechanism 29 to which a drive source 37 is connected, a holder base 43 and a plastically deformable member 53.

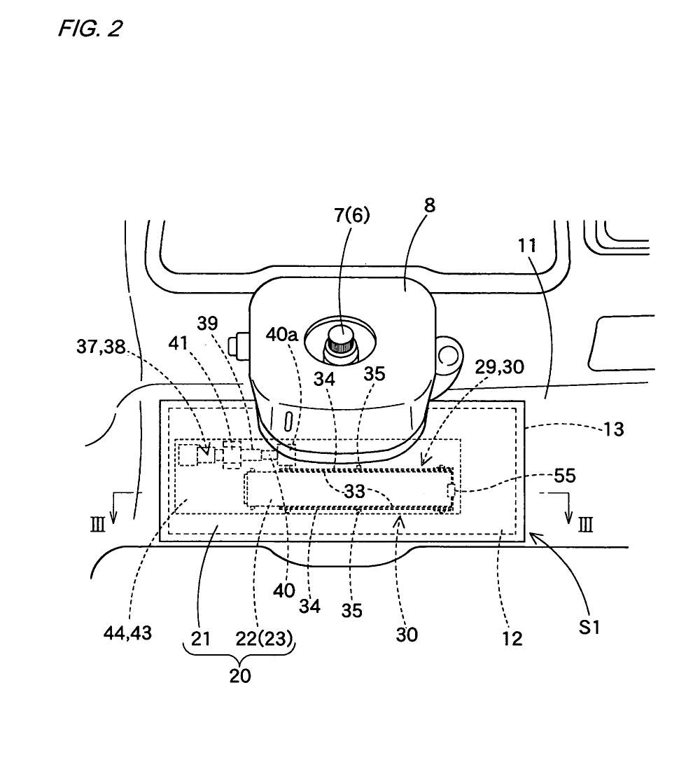

As is shown in FIGS. 6A and 6B, the receiving holder portion 20 is made to include a receiving panel portion 21 which is disposed on a rear surface side thereof so as to be exposed to the driver M side to thereby configure a designed surface and a receiving frame portion 22 which holds the receiving panel portion 21 and which is disposed on a front surface side of the receiving panel portion 21. In addition, the receiving panel portion 21 is formed of a hard synthetic resin or the like which contains a filler and is, as is shown in FIGS. 2, 6A and 6B, disposed so as to close a rectangular opening 12 provided in the instrument panel 11 in a position lying below the column cover 9 and fit on a circumferential portion 13 of the opening 12 when the receiving holder portion 20 is disposed in the waiting position WP.

As is shown in FIGS. 3A to 5, the receiving frame portion 22 is made of a piece of sheet metal having a U-shape section and is made to include a base plate portion 23 having a rectangular plate shape which follows the top-bottom direction and extends in the left-right direction and support walls 24 (24A, 24B) which extend forwards from upper and lower edges 23a, 23b of the base plate portion 23 so as to face each other.

A fixed pivotally supporting portion 25 and a movable pivotally fixed portion 26 are provided on each of the support walls 24A, 24B, and distal end portions 33b, 34b of two links 33, 34 of a parallel link mechanism 30 are pivotally supported (pivotally attached) to the fixed pivotally supporting portion 25 and the movable pivotally supporting portion 26, respectively. The fixed pivotally supporting portion 25 is such as to pivotally support the distal end portion 33b of each link 33 so as to oscillate, and the movable pivotally supporting portion 26 is such as to pivotally support the distal end portion 34b of each link 34 so as to oscillate. The movable pivotally supporting portions 26 are disposed so as to slide, respectively, in slide holes 24a, 24a which are formed so as to extend along the left-right direction in the support walls 24A, 24B. In addition, a fixed pivotally supporting portion 27 is provided at an end portion of each of the support walls 24A, 24B which is situated spaced away from the fixed pivotally supporting portion 25, and a plastically deformable member 53 is provided so as to be supported on (pivotally attached to) this fixed pivotally supporting portion 27.

Note that in the case of the first embodiment, the individual links 33, 34 and the plastically deformable member 53 are disposed so as to oscillate over a plane which follows a substantially horizontal plane.

As is shown in FIG. 1, the holder base 43 is made as a portion which is connected to a body side member 1 of the vehicle and is made to include an attaching base portion 44 and a holding frame portion 45. The attaching base portion 44 is provided on a front side of the opening 12 in the instrument panel 11 which configures the waiting position WP of the receiving holder portion 20 and is fixedly attached to a bracket 3 which extends from an instrument panel reinforcement 2 as the body side member 1. In addition, a base plate portion 46 of the holding frame portion 45 and an actuator 38 which configures the drive source 37 for the drive mechanism 29 are fixedly attached to the attaching base portion 44.

As is shown in FIGS. 3A to 5, the holding frame portion 45 is made of a sheet metal having a U-shape section and is made to include the base plate portion 46 having a rectangular plate shape which follows the top-bottom direction and extends in the left-right direction and support walls 47 (47A, 47B) which extend rearwards from upper and lower edges 46a, 46b of the base plate portion 46 so as to face each other.

A fixed pivotally supporting portion 48 and a movable pivotally supporting portion 49 are provided on each of the support walls 47A, 47B, and proximal portions 33a, 34a of the two links 33, 34 of a parallel link mechanism 30 are pivotally supported (pivotally attached) to the fixed pivotally supporting portion 48 and the movable pivotally supporting portion 49, respectively. The fixed pivotally supporting portion 48 is such as to pivotally support the proximal portion 33a of each link 34 so as to oscillate, and the movable pivotally supporting portion 49 is such as to pivotally support the proximal portion 33a of each link 33 so as to oscillate. The movable pivotally supporting portions 49 are disposed so as to slide, respectively, in slide holes 47a, 47a which are formed so as to extend along the left-right direction in the support walls 47A, 47B.

In addition, a stopper 51 is fixedly provided in the vicinity of a central portion in the left-right direction of the base plate portion 46 so as to lock and support a proximal portion 53a of the plastically deformable member 53 when the receiving holder portion 20 is fed out to the receiving position SP.

As is shown in FIGS. 3A to 5, the drive mechanism 29 is such as, when actuated, to receive a drive force transmitted from the drive source 37 so as to feed out the receiving holder portion 20 from the waiting position WP to the receiving position SP and is disposed so as to be connected to the holding frame portion 45 of the holder base 43 and the receiving frame portion 22 of the receiving holder portion 20. In the case of the first embodiment, the drive mechanism 29 is made up of the parallel link mechanisms 30. Namely, the drive mechanism 29 is made such that the two equally long links 33, 34 are disposed so as to intersect each other on each of corresponding upper edge 23a, 46a sides and corresponding lower edge 23b, 46b sides of the holder base 43 and the receiving holder portion 20 with both the end portions (the proximal portions 33a, 34a and the distal end portions 33b, 34b) of the respective links 33, 34 connected, respectively, to the support walls 47A, 45B of the holding frame portion 45 of the holder base 43 and the support walls 24A, 24B of the receiving frame portion 22 of the receiving holder portion 20. Namely, in each of the two pairs of links, the links 33, 34 are pivotally attached to each other in the vicinity of respective central portions thereof with a pin 35. In addition, the links 33 are connected to the upper and lower support walls 47A, 47B of the holding frame 45 at the proximal portions 33a by making use of the movable pivotally supporting portions 49 so as to slide at the proximal portions 33a within sliding holes 47a in the upper and lower support walls 47A, 47B and to oscillate, and the links 33 are connected to the upper and lower support walls 24A, 24B of the receiving frame portion 22 at the distal end portions 33b by making use of the fixed pivotally supporting portions 25 so as to oscillate. Additionally, the links 34 are connected to the upper and lower support walls 47A, 47B of the holding frame 45 at the proximal portions 34a by making use of the fixed pivotally supporting portions 48 so as to oscillate, and the links 34 are connected to the upper and lower support walls 24A, 24B at the distal end portions 34b by making use of the movable pivotally supporting portions 26 so as to slide at the distal end portions 34b in sliding holes 24a in the upper and lower support walls 24A, 24B and to oscillate. Thus, the drive mechanism 29 is made up of the four-node parallel link mechanisms 30 arranged to face each other vertically which each include the receiving frame portion 22 of the receiving holder portion 20 and the holding frame portion 45 of the holder base 43 which are made to function as link pieces 31, 31 which are parallel to each other and the links 33, 34 as constituent nodes.

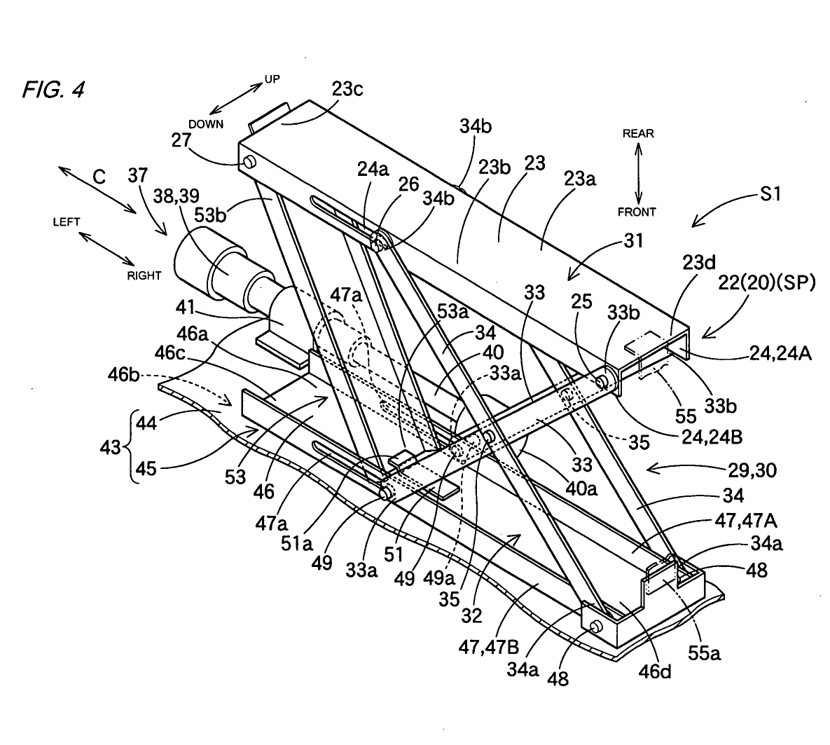

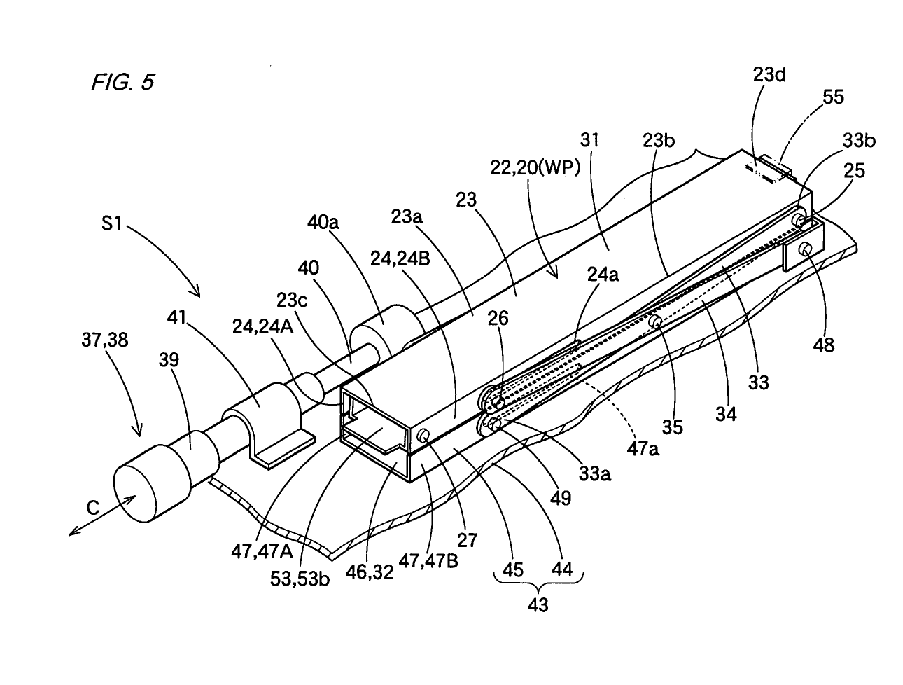

In the parallel link mechanism 30, with the receiving holder portion 20 disposed in the waiting position WP, as is shown at FIG. 3A, the receiving frame portion 22 stays close to the holding frame portion 45, while with the receiving holder portion 20 actuated, as is shown in FIG. 3B and FIG. 4, the links 33, 34 are made to rise or extend while oscillating by the fixed pivotally supporting portions 25, 48 and the movable pivotally supporting portions 26, 49, and the receiving frame portion 22 moves rearwards while kept staying parallel to the holding frame portion 45, whereby the receiving holder portion 20 comes to be disposed in the receiving position SP. Note that while the receiving holder portion 20 is disposed in the waiting position WP, a stopper material 55 which is made up of a breakable tape material is affixed as a restricting member for fastening a right end 23d side of a base plate portion of the receiving frame portion 22 to the base plate portion 46 side so as to restrict a reverse movement of the receiving holder portion 20 (refer to FIG. 3A and FIG. 5).

As is shown in FIGS. 4 and 5, the drive source 37 is made up of the cylinder-type actuator 38 in which a working rod 40 projects from a cylinder 39 when the actuator 38 is actuated. In addition, in the first embodiment, a micro gas generator is provided in an interior of the cylinder 39, and when an actuation signal is inputted, the micro gas generator is ignited so as to generate a predetermined combustion gas. Then, a piston residing in the cylinder 39 is caused to move by making use of the combustion gas so generated, and the working rod 40 which is connected to the piston to thereby project out of the cylinder 39 is caused to move to the right so as to project further from the cylinder 39.

In this actuator 38, in order that the end portion (the proximal portion) 33a of the link 33, which is one of the links disposed on the one edge (the upper edge in this embodiment) 46a side on the holder base 43 side, is caused to move in a direction in which the end portion 33a approaches the end portion (the proximal portion) 34a of the other link 34, an axial direction C of the cylinder 39 is made to follow a moving direction of the proximal portion 33a of the link 33 and a distal end portion 40a of the working rod 40 is connected to the proximal portion 33a of the link 33 (refer to FIG. 4). In addition, the distal end portion 40a is pivotally attached to a shaft 49a of the movable pivotally supporting portion 49 by which the proximal portion 33a is pivotally attached to the support wall 47A side. In addition, this actuator 38 is provided so as to be fixedly attached to the attaching base portion 44 by the use of an attaching bracket 41.

Then, when the actuator 38 is actuated, since the working rod 40 moves its distal end portion 40a to the right while the movable pivotally supporting portion 49 is made to slide in the sliding hole 47a, the proximal end portion 33a of the link 33 approaches the proximal portion 34a side of the link 34, whereby the receiving holder portion 22 is caused to move to the rear from the waiting position WP to the receiving position SP while kept parallel to the holding frame portion 45.

As is shown in FIGS. 3A, 3B and 4, the plastically deformable member 53 is made of a piece of sheet metal having a U-shape section and is pivotally attached to an end portion (a left end) 23c of the receiving frame portion 22 which lies closer to the sliding hole 24a so as to oscillate by making use of the fixed pivotally supporting portions 27 at a distal end portion 53b thereof. A spring (a torsion coil spring) 54 is provided on the periphery of the fixed pivotally supporting portion 27 as a biasing device, so that a proximal portion 53a side of the plastically deformable member 53 which lies closer to the attaching base portion 44 is biased so as to be brought into abutment with the base plate portion 46 of the holding frame portion 45 at all times. In addition, a length dimension DL of the plastically deformable member 53 as measured from the fixed pivotally supporting portion 27 to the proximal portion 53a is set to a longer dimension which is longer than a feeding out distance SL as measured from the base plate portion 23 to the fixed pivotally supporting portion 27 along the front-rear direction when the receiving holder portion 20 is fed out to the receiving position (refer to FIG. 3B). Because of this, in the plastically deformable member 53, with the proximal portion 53a side acting as a free end, the proximal portion 53a is disposed closer to an end portion (a right end) 46d side of the base plate portion 46 which lies on the proximal portion 34a side of the link 34 when the receiving holder portion 20 is disposed in the waiting portion WP on the holder base 43 side, whereas when the receiving holder portion 20 is fed out to the receiving position SP which is spaced away from the holder base 43, the proximal portion 53a is disposed closer to the other end portion (a left end) 46c of the base plate portion 46.

The stopper 51 is provided on the base plate portion 46 so as to be oriented towards the left end 46c side so as to lock and support the proximal end portion 53a when the receiving holder portion 20 is fed out to the receiving position SP. This stopper 51 is made of a piece of sheet metal and is provided so as to extend from the right end 46d side to the left end 46c side in a stepped fashion so as to cause a locking piece portion 51a at a distal end thereof to rise towards the rear of the vehicle.

In addition, the plastically deformable member 53 has a lower rigidity than those of the stopper 51, the links 33, 34, the receiving frame portion 22 and the holding frame portion 45, so that the plastically deformable member 53 is easy to be bent and plastically deformed. Incidentally, the plastically deformable member 53 is made to be plastically deformed in such a state that the proximal portion 53a is locked to be supported by the locking piece portion 51a of the stopper 51 when the receiving holder portion 20 which has been disposed in the receiving position SP receives the knees K which are being caused to move forwards and them attempts to move back towards the waiting position WP and that the distal end portion 53b is supported such that its position is restricted by the receiving frame portion 22 by making use of the fixed pivotally supporting portions 27, and as this occurs, the plastically deformable member 53 is bent and plastically deformed between the proximal portion 53a and the distal end portion 53b thereof.

Further, in the first embodiment, the actuator 38 is configured such that its operation is controlled by a control unit 15. The control unit 15 is electrically connected with a sensor 16 for detecting a frontal collision of the vehicle. Then, when it has received a signal from the sensor 16 while taking the vehicle speed and the like into consideration to detect a frontal collision of the vehicle, the control unit 15 actuates the actuator 38.

Namely, in this receiving system S1, when the control unit 15 (refer to FIG. 1) detects a frontal collision of the vehicle based on the signal from the sensor 16, the actuator 38 is actuated by the control unit 15. When the actuator 38 is actuated to operate, since the working rod 40 causes the distal end portion 40a to move to the right with the movable pivotally supporting portions 49 allowed to slide in the corresponding slide holes 47a, the proximal portion 33a sides of the links 33 approach the proximal portion 34a sides of the links 34. Because of this, as is shown in FIGS. 6A and 6B, with the stopper material 55 broken, the receiving holder portion 20 is fed out from the waiting position WP where the receiving frame portion 22 is caused to lie close to the holding frame portion 45 and the receiving panel portion 21 is caused to be accommodated in the opening 12 in the instrument panel 11 to the receiving position SP. Namely, in the parallel link mechanisms 30, the links 33, 34 are caused to rise or extend at the fixed pivotally supporting portions 25, 48 and the movable pivotally supporting portions 26, 49 while being caused to oscillate, so as to cause the receiving frame portion 22 to move to the rear while kept parallel to the holding frame portion 45, and the receiving holder portion 20 is caused to be disposed in the receiving position SP. As this occurs, the plastically deformable member 53 is locked by the locking piece portion 51a of the stopper 51 at the proximal portion 53a side.

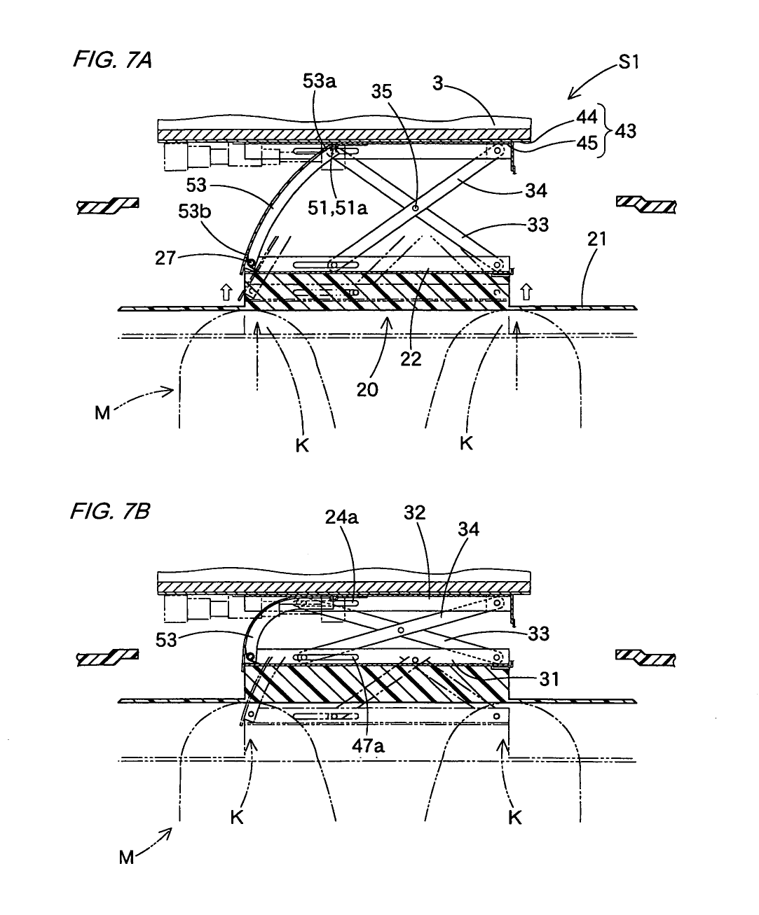

The, the knees K, which function as the moving body which moves forwards, are received by the receiving panel portion 21 of the receiving holder portion 20, and when the receiving holder portion 20 moves forwards to the waiting position WP side together with the knees K, as is shown FIGS. 7A and 7B, the plastically deformable member 53, which is in the state where the proximal portion 53a is locked in the locking piece portion 51a of the stopper 51 and the distal end portion 53b is restricted with respect to its position by the fixed pivotally supporting portions 27, is bent and plastically deformed, so as to absorb the kinetic energy of the knees K.

As this occurs, since the plastically deformable member 53 is configured as a separate element from the receiving holder portion 20 and is supported on the holder base 43 and the receiving holder portion 20, when the receiving holder portion 20 moves towards the holder base 43 side, the supported portion (the distal end portion 53b or the fixed pivotally supporting portions 27) of the plastically deformable member 53 which is supported on the receiving holder portion 20 moves in accordance with the moving amount of the receiving holder portion 20 towards the holder base 43 side relative to the supported portion (the proximal portion 53a or the stopper 51) side which is supported on the holder base 43 (in the case of the illustrated example, an approaching movement). As a result of this, the plastically deformable member 53 is bent and plastically deformed in accordance with the moving amount of the receiving holder portion 20, whereby the kinetic energy of the knees K can be absorbed. In other words, the plastically deformable member 53 is not interposed between the receiving holder portion 20 and the drive mechanism 29 but is arranged such that the end portion (the proximal portion) 53a, which is one of the end portions, is made to be supported so as to be locked in the locking piece portion 51a of the stopper 51 and the other end (the distal end portion) 53b is made to be supported on the left end 23c side of the receiving holder portion 20 by making use of the fixed pivotally supporting portions 27. In this configuration, even though the receiving holder portion 20 moves from the receiving position SP to the vicinity of the waiting position WP, the plastically deformable member 53 is allowed to be plastically deformed over the full length of the long moving stroke of the receiving holder portion 20.

In addition, in this receiving system S1, the absorption of the kinetic energy of the knees K is implemented by virtue of the plastic deformation of the plastically deformable member 53, and since this has nothing to do with the damper mechanism which involves the controlled discharge of the gas from the vent holes, when the receiving holder portion 20 receives the knees K having high kinetic energy, the plastically deformable member 53 is plastically deformed in a smooth fashion without imparting a high reaction force to the knees KI, so as to absorb a predetermined quantity of kinetic energy.

Consequently, in the receiving system S1 of the first embodiment, the kinetic energy of the knees K, which functions as the moving body, can be absorbed by virtue of the plastic deformation of the plastically deformable member 53, and the long moving stroke can easily be ensured when kinetic energy is absorbed.

In addition, in the receiving system S1 of the first embodiment, while being interposed between the receiving holder portion 20 which is being disposed to the receiving position SP and the holder base 43, the plastically deformable member 53 is arranged such that the distal end portion 53b, which configures one of both the ends of the plastically deformable member 53, is caused to be supported on the left end 23c of the receiving frame portion 22 of the receiving holder portion 20 by making use of the fixed pivotally supporting portions 27, whereas the proximal portion 53a, which configures the other end, is caused to be supported on the base plate portion 46 on the holder base 43 side by making use of the stopper 51. Namely, in the plastically deformable member 53, with the proximal portion 53a caused to be supported on the holder base 43 side, the distal end portion 53b is not connected to the drive mechanism 29 but is cause to be supported directly on the base plate portion 23 of the receiving frame portion 22 of the receiving holder portion 20 which moves to the waiting position WP side. Because of this, since the plastically deformable member 53 can be pressed against directly by the receiving holder portion 20 itself when the receiving holder portion 20 moves to the waiting position WP side, so as to be plastically deformed, the absorbing amount of kinetic energy becomes easy to match accurately the moving stroke of the receiving holder portion 20 towards the waiting position WP side, whereby the kinetic energy of the knees K can be absorbed in a smooth fashion.

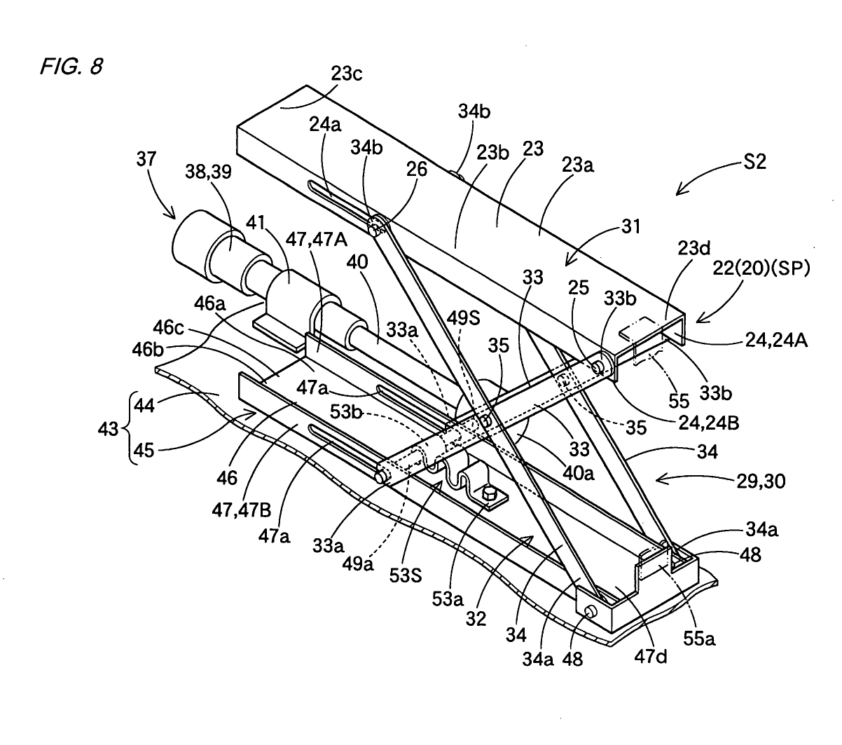

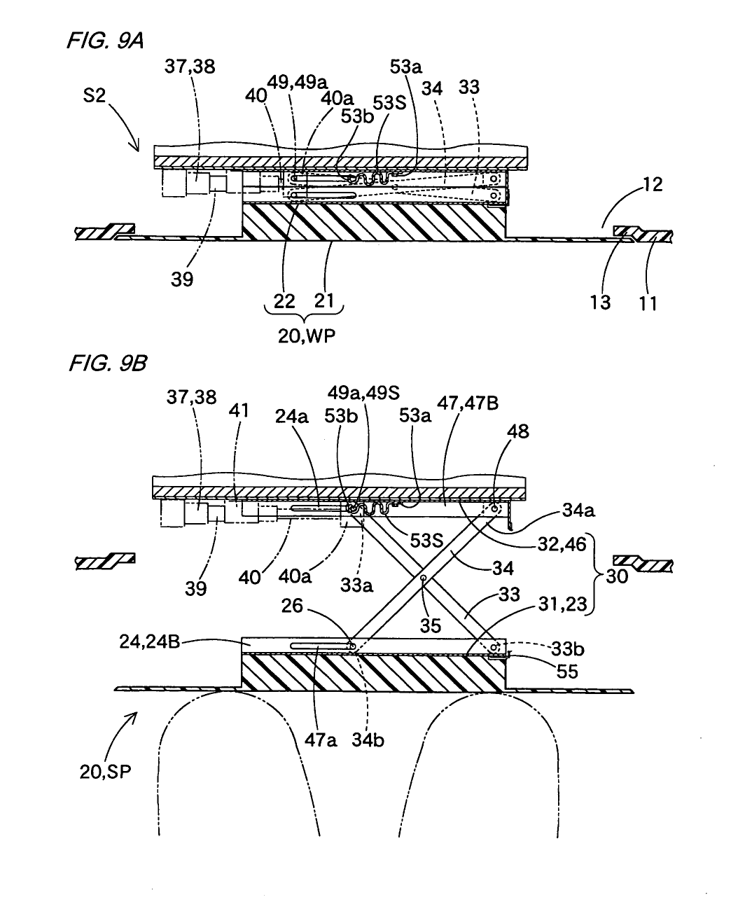

In addition, without taking this into consideration, as in a plastically deformable member 53S of a receiving system S2 of a second embodiment which is shown in FIGS. 8 to 10B, a proximal portion 53a may be connected to a holder base 43, and a distal end portion 53b may be connected not to a receiving holder portion 20 but to proximal portions 3a of links 33 in a drive mechanism 29. This plastically deformable member 53S is made of a curved metal which can be plastically deformed when it is pulled to be straightened and is arranged such that the proximal portion 53a is fixedly attached to a base plate portion 46 of a holding frame portion 45 of the holder base 43 and the distal end portion 53b is caused to extend to the left while being curved or corrugated. In addition, a shaft 49a of a movable pivotally supporting portion 49S is connected to a distal end portion 40a of a working rod 40 of an actuator 38 and the proximal portions 33a of the links 33 which face each other vertically are connected to each other. In addition, when the actuator 38 is actuated to operate and the shaft 49a of the movable pivotally supporting portion 49S moves to a right-hand side together with the distal end portion 40a of the working rod 40, as is shown in FIGS. 9A and 9B, the shaft 49a is locked by the hook-like curved distal end portion 53b of the plastically deformable member 53S, so that a return movement of the shaft 49a towards a left-hand side is made to be restricted by the distal end portion 53b.

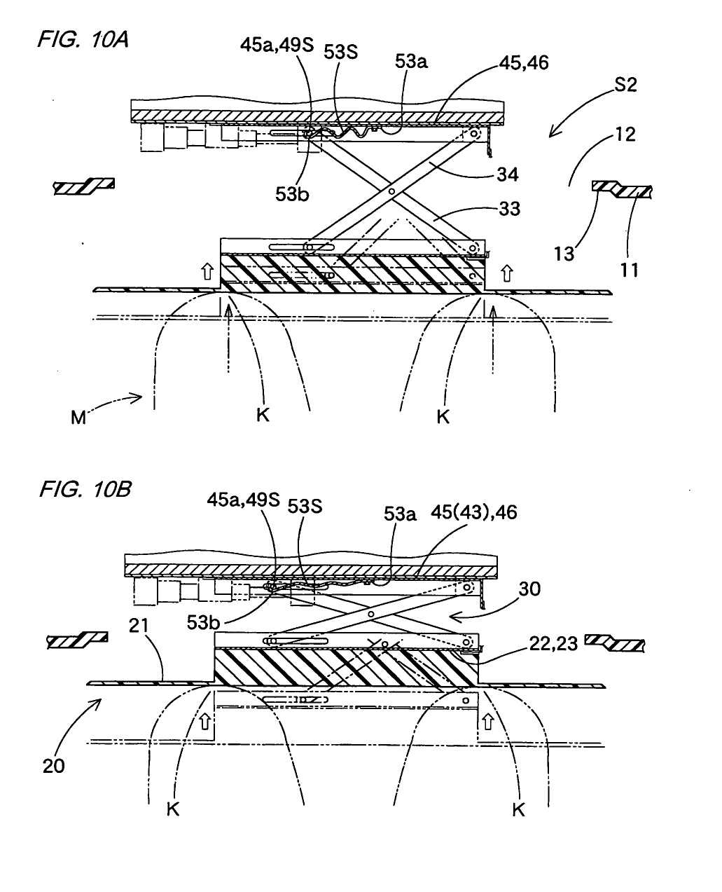

Namely, in the receiving system S2 of the second embodiment, when the receiving holder portion 20 has been fed out from a waiting position WP to a receiving position SP by virtue of the operation of the actuator 38, as is shown at A, B in FIGS. 9A, 9B and 8, the distal end portion 53b of the plastically deformable member 53S is locked on the shaft 49a which is connected to the proximal portions 33a, 33a of the links 33 of the drive mechanism 29. In addition, thereafter, knees K, which function as a moving body which moves forwards, are received by a receiving panel portion 21 of the receiving holder portion 20 which is then disposed in the receiving position SP. Further, when the receiving holder portion 20 moves to a front side which configures the waiting position WP side together with the knees, as is shown in FIGS. 10A and 10B, the proximal portions 33a, 33a of the links 33 move to a left end 46c side of a base plate portion 46 which configures a position where they are disposed when the receiving holder portion 20 is disposed in the waiting position WP. Because of this, since the plastically deformable member 53 is arranged such that the proximal portion 53a is fixed to the base plate portion 46 of the holder base 43 and the distal end portion 53b is locked on the shaft 49a, the distal end portion 53b which is locked on the shaft 49a is caused to move relative to the proximal portion 53a so as to be spaced apart from the proximal portion 53a as the shaft 49a which is connected to the proximal portions 33a, 33a of the links moves towards the left end 46c side of the base plate portion 46. Then, the plastically deformable member 53S is plastically deformed such that the curved portion is pulled to be straightened so as to absorb the kinetic energy of the knees K. As in the receiving system S2 of the second embodiment, the plastically deformable member 53A may be configured such that the proximal portion 53a is caused to be supported on the holder base 43, and the distal end portion 53b is caused to be supported not on the receiving holder portion 20 but on the proximal portions 33a of the links 33 in the drive mechanism 29 by making use of the shaft 49a of the movable pivotally supporting portions 49S.

In addition, in the first embodiment, the drive mechanism 29 is made up of the parallel link mechanisms 30 in which the two equally long links 33, 34 are caused to intersect each other on each of both the (upper and lower) edges 23a, 23b, 46a, 46b of the holder base 43 and the sizing and holding portion 20 and the both end portions (the proximal portions 33a, 34a and the distal end portions 33b, 34b) of the respective links 33, 34 are connected respectively to the holding frame portion 45 of the holder base 43 and the receiving frame portion 22 of the receiving holder portion 20. Because of this, in the parallel link mechanisms 30 configured in this way, the drive mechanism 29 can be made compact enough to be stored within the volume equaling the thickness of the receiving system S1 which is defined between the receiving holder portion 20 and the holder base 43 when the receiving holder portion 20 is disposed in the waiting position WP.

Further, in the first embodiment, the drive source 37 is made up of the cylinder type actuator 38 in which when actuated, the working rod 40 is caused to project form the cylinder 39, and this actuator 38 is arranged such that the axial direction C of the cylinder 39 is made to follow the moving direction of the proximal portion 33a of the link 33 and the distal end portion 40a of the working rod 40 is connected to the proximal portion 33a of the link 33 so that when the actuator 38 is actuated, the end portion (the proximal portion) 33a of one of the links 33 on the one (upper) edge 46a side on the holder base 43 side is caused to move in the direction in which it approaches the end portion (the proximal portion) 34a of the other link 34. Namely, the projecting direction of the working rod 40 which is fed out by the actuator 38 as the drive source 37 when it is actuated is referred to as the direction (the left-right direction) which is at right angles to the feeding out direction (to the rear) of the receiving holder portion 20 towards the receiving position SP and the rightward direction which follows the moving direction of the proximal portion 33a of the link 33, whereby the axial direction C of the cylinder 39 does not have to be disposed so as to be bulky in the feeding out direction of the receiving holder portion 20. Because of this, in the configuration like this, the thickness dimension which follows the feeding out direction of the receiving holder portion 20 (the thickness dimension in the front-rear direction) can be made small, whereby the receiving system S1 can be configured compact in size and thin in thickness.

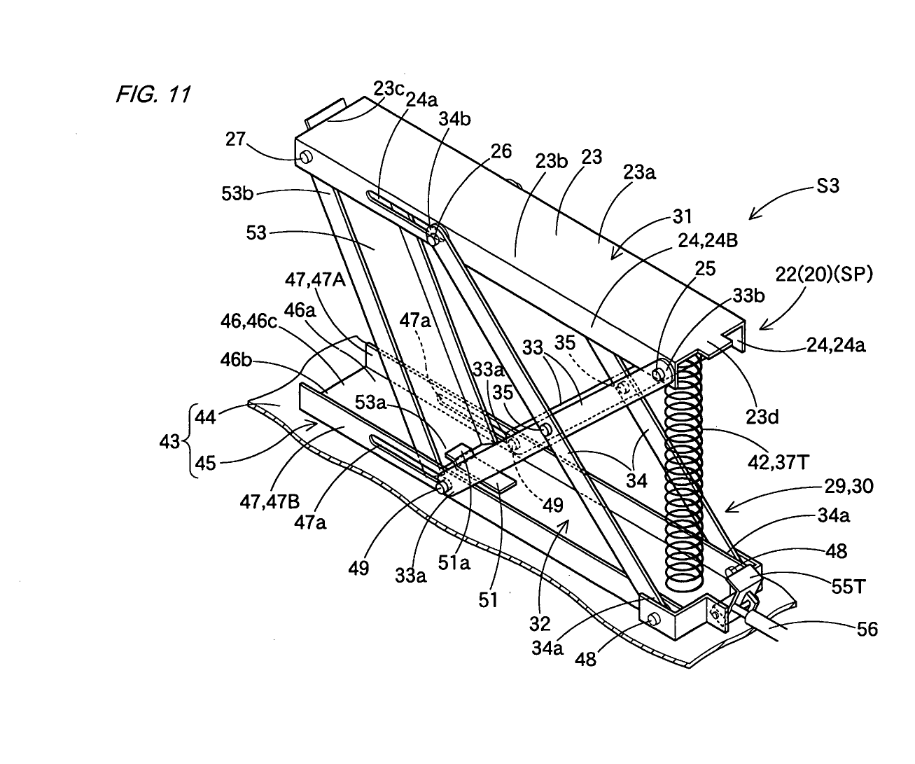

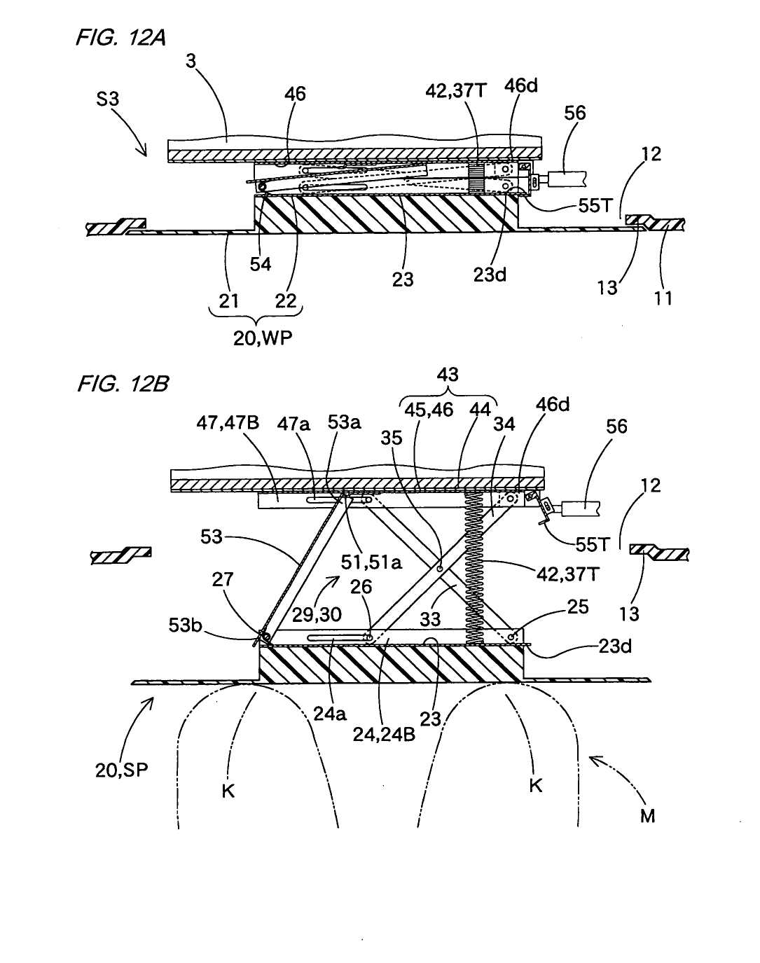

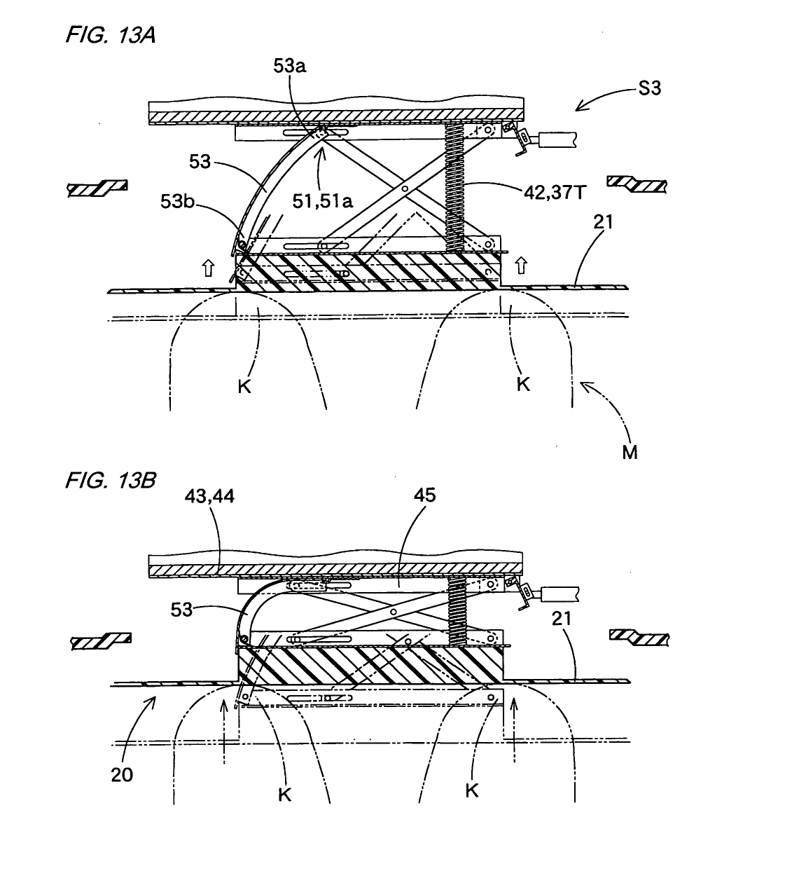

In addition, as the drive source, in addition to using the micro gas generator, a cylinder type actuator may be used which employs hydraulic pressure or air pressure, or a motor may be used which employs electric power, hydraulic pressure or air pressure. Further, as in a receiving system S3 of a third embodiment which is shown in FIGS. 11 to 13B, a spring 42 may be used as a drive source 37T. In this receiving system S3, a spring (a compression coil spring) 42 is interposed between a base plate portion 23 of a receiving frame portion 22 of a receiving holder portion 20 and a base plate portion 46 of a holding frame portion 45 of a holder base 43, and the separation of right ends 23d, 46d of the base plate portions 23, 46 from each other is prevented by an L-shaped stopper material 55T which locks the right end 23d (refer to FIG. 12A). Then, an electromagnetic solenoid 56 is actuated so that the stopper material 55T is moved to be pulled out so as to release the locking of the right end 23d (refer to FIG. 12B), whereby the base plate portion 23 of the receiving frame portion 22 of the receiving holder portion 20 is caused to be spaced apart from the base plate portion 46 of the holding frame portion 45 of the holder base 43 by virtue of the biasing force of the spring 42, so that the receiving holder portion 20 is made to be fed out from a waiting position WP to a receiving position SP. In addition, in this receiving system S3, in the event that the receiving holder portion 20 is disposed in receiving position SP when the receiving system 3 is actuated, as is shown in FIGS. 13A and 13B, a plastically deformable member 53 causes a proximal portion 53a thereof to be locked in a locking piece portion 51a of a stopper 51, whereby as with the first embodiment, the kinetic energy of knees K can be absorbed by virtue of the bending plastic deformation of the plastic deformable member 53.

Note that while in the respective embodiments, the receiving systems S1, S2, S3 have been described as being designed to receive the knees K of the driver as a moving body to be received, the invention may be applied to a moving body receiving system for receiving a moving body such as knees of a front seat passenger, an upper half body of an occupant including the drive, a pedestrian himself or her self who is hit by the vehicle or a hood panel on an upper surface of which the pedestrian hit by the vehicle is resting so as to stop those moving bodies with safe by reducing the kinetic energy thereof.

What is claimed is:

1. A moving body receiving system which is installed on a vehicle and is adapted, when actuated, to feed out a receiving holder portion from a waiting position to a receiving position where the receiving holder portion can receive a moving body and absorb kinetic energy of the moving body when the receiving holder portion which has received the moving body moves towards the waiting position, comprising:
a holder base which is fixed to a waiting position side of the receiving holder portion;
a drive mechanism connected to the holder base and the receiving holder portion to receive a drive force transmitted from a drive source so as to feed out the receiving holder portion from the waiting position to the receiving position; and
a plastically deformable member separately formed from the receiving holder portion, is supported on the holder base and either the receiving holder portion or the drive mechanism and is made to be plastically deformed when the receiving holder portion which is placed in the receiving position moves back towards the waiting position so as to absorb the kinetic energy of the moving body.

2. A moving body receiving system as set forth in claim 1, wherein
the plastically deformable member is interposed between the receiving holder portion which is being placed to the receiving position and the holder base and is arranged such that one of both ends thereof is made to be supported on the receiving holder portion side and the other is made to be supported on the holder base side.

3. A moving body receiving system as set forth in claim 1, wherein
the drive mechanism is made up of parallel link mechanisms in each of which two equally long links are disposed to intersect each other on either of corresponding edge sides of the holder base and the receiving holder portion with both end portions of each link connected, respectively, to the holder base and the receiving holder portion which are made to function as link pieces which are parallel to each other.

4. A moving body receiving system as set forth in claim 3, wherein
the drive source is made up of a cylinder-type actuator in which a working rod is made to project from a cylinder when actuated, and wherein
the actuator is arranged such that an axial direction of the cylinder is made to follow a moving direction of the end portion of one of the two links which are disposed on one of the edge sides on the holder base side and a distal end of the working rod is connected to the end portion of the one of the two links so that when actuated, the end portion of the one of the two links moves in a direction in which it approaches the corresponding end portion of the other of the two links.
